(19) United States
(12) Patent Application Publication
(10) Pub. No.: US 2016/0046240 A1
(43) Pub. Date: Feb. 18, 2016

(54) SEAT ASSEMBLY WITH EMBEDDED AND HIDDEN STORAGE

(71) Applicant: FORD GLOBAL TECHNOLOGIES, LLC, Dearborn, MI (US)

(72) Inventors: Jezahel Lara sandoval, Mexico City (MX); Fernando Lara, Naucalpan (MX); Gerardo Diaz Paredes, Mexico City (MX); Steve Walter Nunez, South Lyon, MI (US); Bhavani Thota, Sterling Heights, MI (US)

(21) Appl. No.: 14/458,570

(22) Filed: Aug. 13, 2014

(51) Int. Cl. B60R 7/04; B60N 2/02; E05G 1/04; B60N 2/24

(52) U.S. Cl. CPC B60R 7/043; B60N 2/24; B60N 2/02; E05G 1/04

(57) ABSTRACT

A seat assembly is provided including a seat back and a seat cushion. The seat cushion includes a seating surface, a first side bolster, a second side bolster and a face extending around the first and second side bolsters and across the front of the seat between those side bolsters. In addition a first storage compartment is provided in the seat cushion. That storage compartment has an access opening in the face.

### TECHNICAL FIELD

This document relates generally to the vehicle seating field and, more particularly, to a new and improved vehicle seat assembly incorporating embedded and hidden storage.

### BACKGROUND

Vehicle purchasers and operators express a strong desire for additional and more versatile storage in their motor vehicles. This need and desire is particularly important in the smaller, more economical vehicles where storage space is at a premium.

This document relates to a new and improved seat assembly incorporating various imbedded and hidden storage molded into the seat foam pad.

### SUMMARY

In accordance with the purposes and benefits described herein, a seat assembly is provided comprising a seat back, a seat cushion including a seating surface, a first side bolster, a second side bolster and a seat face. The seat face extends around the two side bolsters and across the front of the seat. The seat assembly further includes a first storage compartment in the seat cushion. The storage compartment has an access opening in that face. In one possible embodiment, a cover overlies the access opening. In another possible embodiment, a security lock is provided for the cover.

In one possible embodiment, the first storage compartment is provided in the first bolster. In one possible embodiment, a second storage compartment is provided. In this embodiment the first storage compartment may be provided in the first side bolster and the second storage compartment may be provided in the second side bolster. In one possible embodiment, the first and/or second storage compartment is tubular in shape.

In yet another possible embodiment, the seat assembly includes a third storage compartment having a third access opening provided in the face between the first and second bolsters. In one possible embodiment, the third storage compartment includes a third cover overlying the third access opening.

In yet another possible embodiment, the seat assembly includes a fourth storage compartment in the seat cushion having a fourth access opening and a fourth cover forming a part of the seating surface. In one possible embodiment the first, second, third and fourth storage compartments are all molded plastic bins embedded in the seat cushion.

In one possible embodiment, the security lock is an electronic security lock. That security lock is connected to a control module including a computing device. The control module further includes a human interface for entering a security code and operating the security lock. In another possible embodiment, the control module includes a speech processor for voice recognition and voice entry of the security code for operating the security lock.

In accordance with an additional aspect, the seat assembly may be described as comprising a seat back, a seat cushion and a storage compartment provided in the seat cushion. That storage compartment includes an access opening, a cover for the access opening and an electronic security lock for the cover. Further the seat assembly includes a control module for operating the electronic security lock. The control module includes a computing device. In any of the embodiments, the cover may be provided in a face of the seat assembly so as to be readily accessible.

In the following description, there is shown and described several preferred embodiments of the seat assembly. As it should be realized, the seat assembly is capable of other, different embodiments and its several details are capable of modification in various, obvious aspects all without departing from the seat assembly as set forth and described in the following claims. Accordingly, the drawings and descriptions should be regarded as illustrative in nature and not as restrictive.

### BRIEF DESCRIPTION OF THE DRAWINGS

The accompanying drawings incorporated herein and forming a part of the specification, illustrate several aspects of the seat assembly and together with the description serve to explain certain principles thereof. In the drawings:

FIG. 1 is a fragmentary and detailed perspective view of a first embodiment of a seat assembly incorporating a storage compartment in a side bolster.

FIG. 2 is a cross-sectional view of the seat assembly illustrated in FIG. 1.

FIG. 3 is a fragmentary perspective view of a second embodiment of the seat assembly wherein the storage compartment in the side bolster includes a cover over the access opening.

FIG. 4 is a perspective view of another embodiment of the seat assembly including storage compartments in the side bolsters, the center face and the seat cushion.

FIG. 5 is a cross-sectional view illustrating the storage compartment in the center face section of the seat wherein that storage compartment incorporates a cover over the access opening.

FIG. 6 is a schematical block diagram of a control system including electronic security lock for a cover on one of the storage compartments in any of the seat assemblies previously illustrated.

FIG. 7 illustrates a tubular shaped storage compartment.

Reference will now be made in detail to the present preferred embodiments of the seat assembly, examples of which are illustrated in the accompanying drawings.

### DETAILED DESCRIPTION

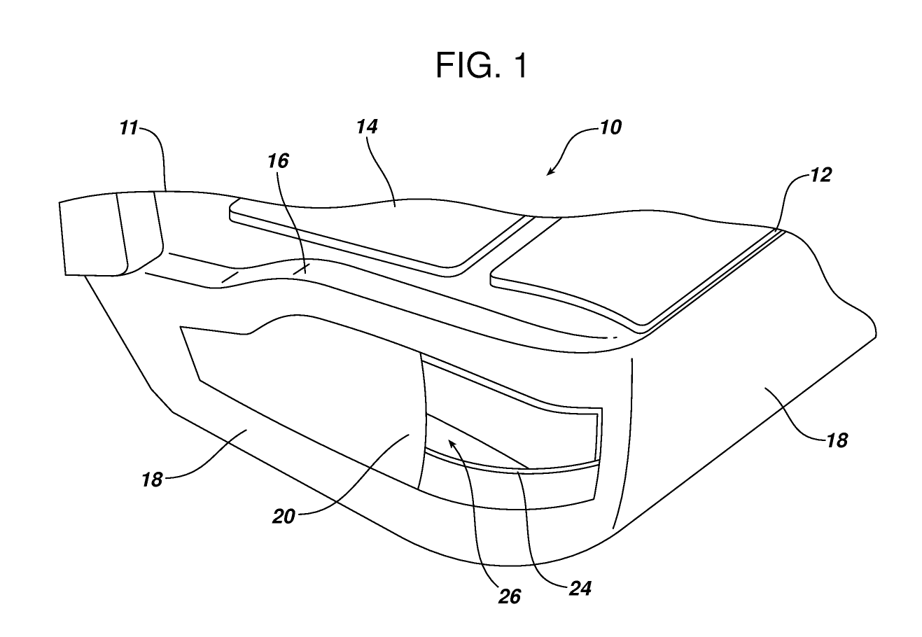

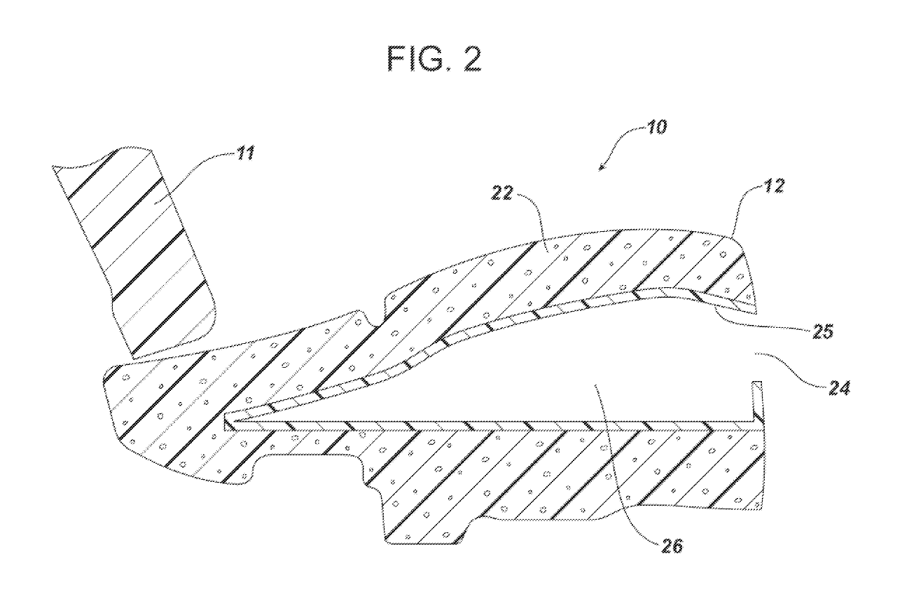

Reference is now made to FIG. 1 illustrating a first embodiment of a seat assembly 10 incorporating, embedded and, if desired, hidden storage. As illustrated, the seat assembly 10 includes a seat back 11, a seat cushion 12 including a seating surface 14, a side bolster 16 and a face 18 extending around the first side bolster across the front of the seat to and around the opposite side bolster (not shown) of the seat assembly 10. As illustrated, a first storage compartment 20 is provided in the seat cushion 12. The storage compartment 20 comprises a molded plastic bin 25 received and held in a hollow or recess of the seat cushion foam 22 (see FIG. 2). An access opening 24 allows one to access the interior storage space 26 of the storage compartment 20.

The seat cushion foam 22 may be a polyurethane foam or other appropriate foam material. The seat cushion foam 22 may be freestanding or include a series of supports (not shown). The storage compartment 20 may be molded from any appropriate plastic material including polyethylene, polypropylene, ABS, nylon, TPO or even combinations thereof.

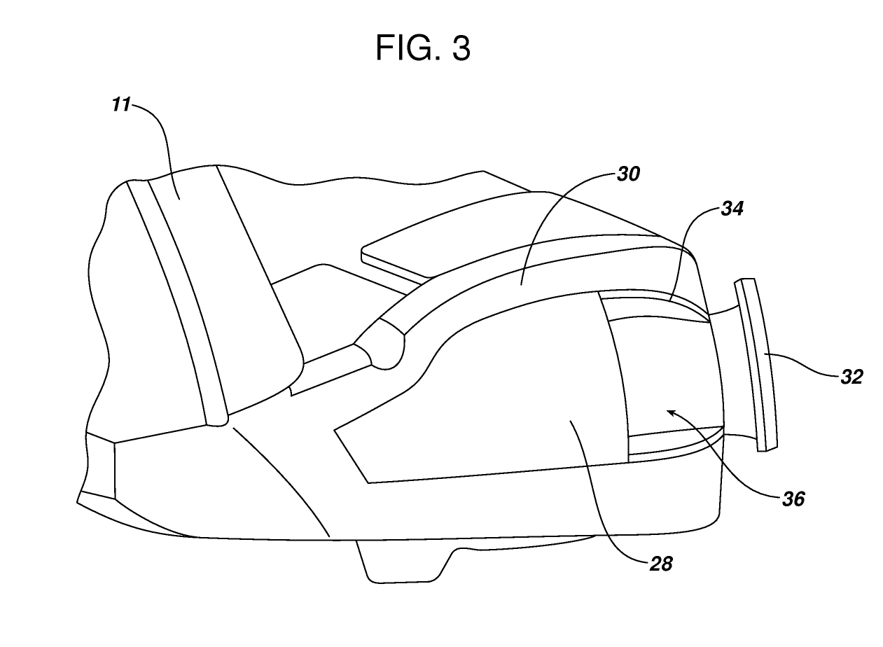

FIG. 3 illustrates an alternative embodiment wherein the storage compartment 28 in the side bolster 30 includes a hinged door or cover 32 which may be used to close the access opening 34 to the interior storage compartment 36. As will be described in greater detail below, that cover 32 may include a security lock (not shown in FIG. 3).

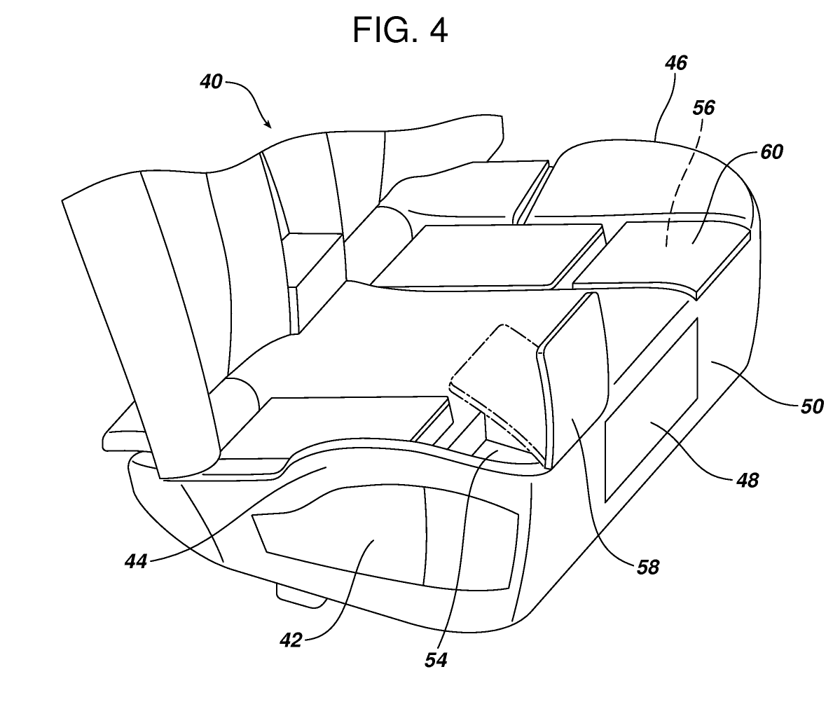

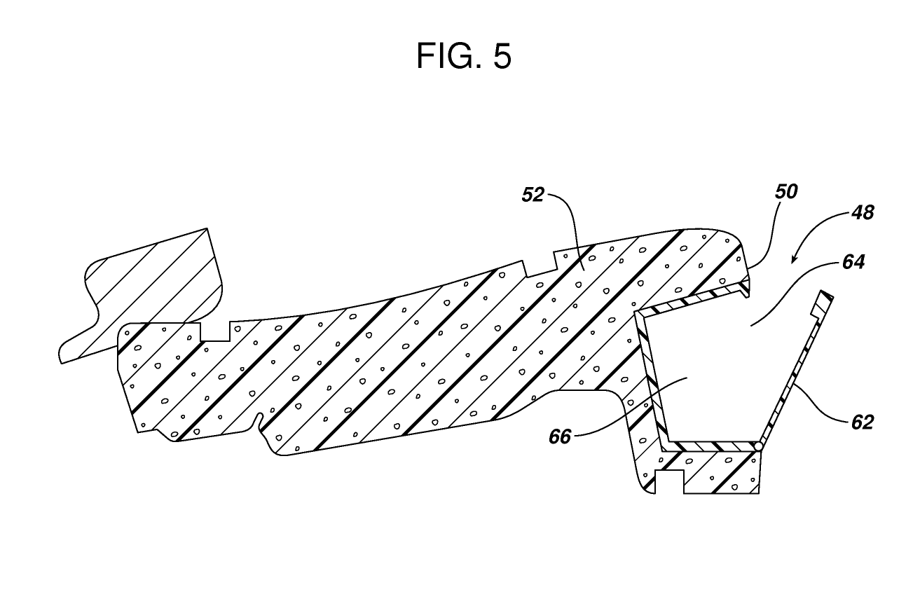

FIG. 4 discloses yet another alternative embodiment of seat assembly 40. This embodiment includes a first storage compartment 42 in the first side bolster 44 identical and designed to that illustrated in FIG. 3, a second storage compartment (not shown) in the second or opposite side bolster 46, a third storage compartment 48 in the front center face 50 of the seat cushion 52 and fourth and fifth storage compartments 54, 56 in the seat cushions having covers 58, 60 that form a part of the seating surface when the covers are closed. FIG. 5 provides a cross-sectional view of the storage compartment 48 in the center face 50 of the seat cushion 52. In the illustrated embodiment that storage compartment 48 includes a hinged cover or door 62 and when closed, seals the access opening 64 to the in interior 66 of the storage compartment.

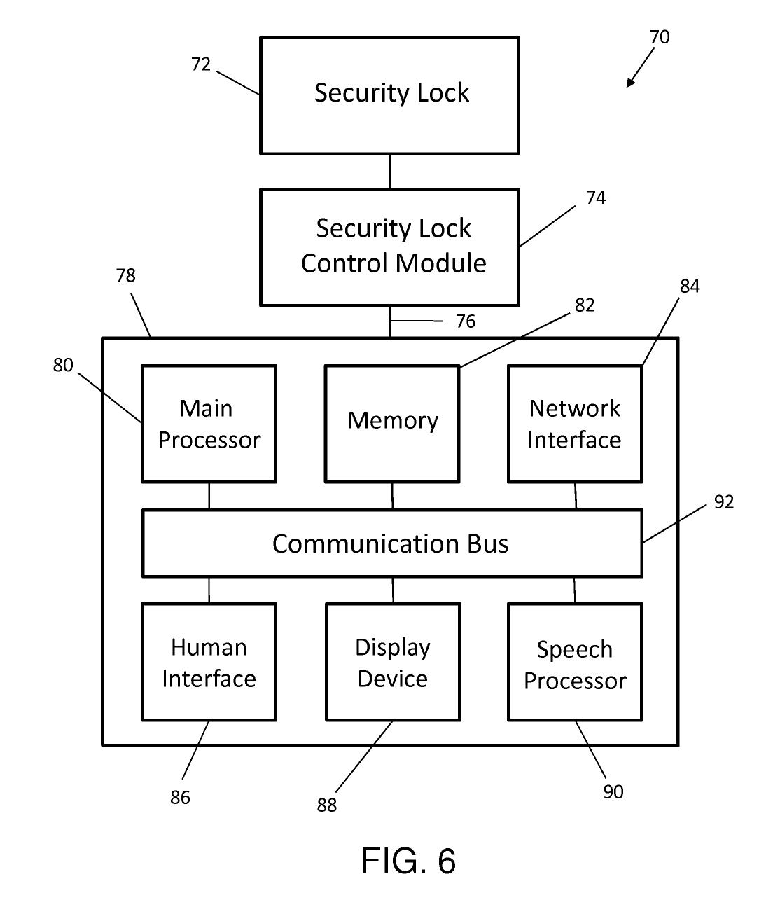

Reference is now made to FIG. 6 schematically illustrating a security lock system 70 for any or all of the storage compartments 20, 28, 42, 48, 54 and/or 56 of the illustrated embodiments. The security lock system 70 includes a security lock 72 that may be used to lock any of the covers or doors 32, 58, 60, 62 on any of the storage compartments. While only one security lock 72 is illustrated, it should be appreciated that one security lock may be provided on each and every door if desired. The security lock 72 comprises an electronic latch pawl provided on the door/cover or seat and cooperating striker provided on the other of the door/cover or seat that may be used to lock the door in the closed position and released to allow the door to be opened. The security lock 72 is operatively connected to a security lock control module 74 which may comprise a computing device such as a microprocessor controller. The security lock control module 74 is operatively connected by control line 76 to a body control module 78.

Body control module 78 includes a computing device having a main processor 80, a memory 82, a network interface 84, a human interface 86, a display device such as a multifunction display with touchscreen capability 88 and a speech processor 90 that all communicate with each other over a communication bus 92. The body control module 78 performs a number of interior body electrically based functions including, for example, interior locking, remote key entry, interior light, exterior light, windshield wiper control and the like. In some embodiments, the body control module 78 may also function to control entertainment functions (e.g. radio, CD player, etc. and communications such as telephone and Internet communication over a wireless network). In some embodiments, the body control module 78 is connected by a communication bus to other control modules that provide one or more of these additional functions.

In the illustrated embodiment, the security lock system 70 may be controlled by requiring a code to lock and unlock various security locks 72. The security lock may have independent codes/keys to unlock each cover/door. In one possible embodiment this is done by means of voice commands. For example, the operator may state, “lock seat storage bins, security code WCS 1911”. The speech processor 90 would process the voice command and operate in conjunction with the main processor 80 to provide a control signal through the control line 76 to the security lock control module 74 causing the security lock 72 to be placed in the locked condition. A similar voice command could be utilized to unlock the covers 32, 58, 60, 62 to the seat storage bins or compartments. Alternatively, the operator could utilize the touchscreen display device 88 to enter the necessary code to lock and unlock the covers 32, 58, 60, 62 of the storage compartments. In still other embodiments, the covers 32, 58, 60, 62 could be locked or unlocked remotely via wireless internet connection if desired through the network interface 84 of the body control module 78. In any of the embodiments, however, it should be appreciated that the security code must be provided.

In summary, numerous benefits result from the seat assembly and embodiments described in this document. Advantageously, the seat assemblies provide additional, versatile storage without sacrificing occupant space. Further, this is achieved without degrading the comfort provided by the seat cushion. In some embodiments the covers 32, 58, 60, 62 for the storage compartments may be designed to be nearly invisible so that the storage compartments are unseen to those who do not know they are there. The security locks 72 provided on the covers 32, 58, 60, 62 may be entirely electronic and keyless and thus hidden from view and also invisible. This provides added security for those items that the vehicle operator wishes to store in the compartments out of sight.

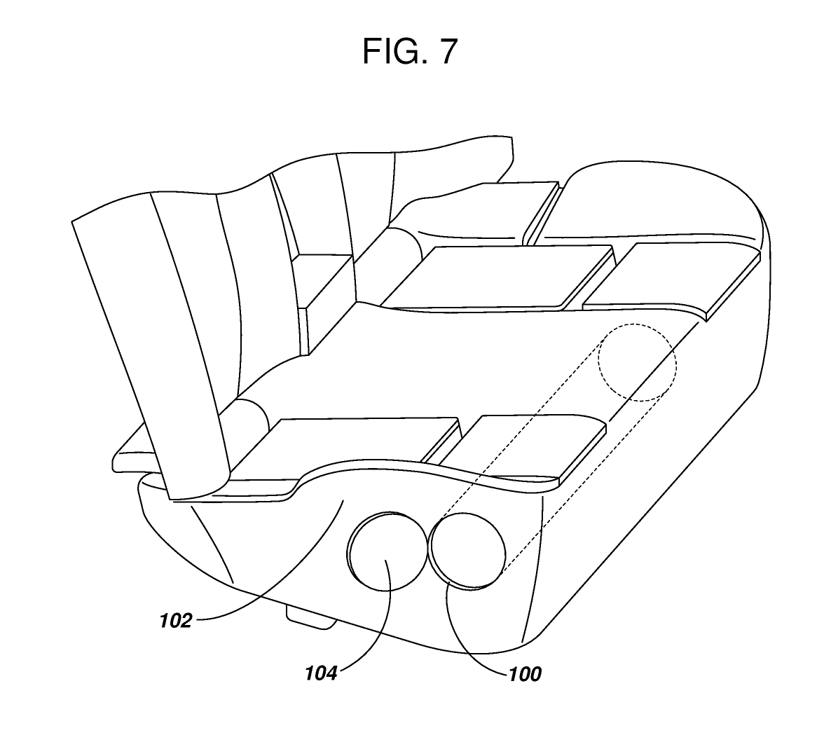

The foregoing has been presented for purposes of illustration and description. It is not intended to be exhaustive or to limit the embodiments to the precise form disclosed. Obvious modifications and variations are possible in light of the above teachings. For example, as illustrated in FIG. 7, the storage compartment 100 in one of the seat bolsters 102 may be tubular or cylindrical in shape. Such a compartment 100 may be deep so as to provide storage for long, thin articles such as fishing rods. The cover 104 is optional. Further while hinged covers are shown and described, it should be appreciated that other cover designs could be used including, but not necessarily limited to, sliding covers and pop off covers. All such modifications and variations are within the scope of the appended claims when interpreted in accordance with the breadth to which they are fairly, legally and equitably entitled.

What is claimed:

1. A seat assembly, comprising:
a seat back;
a seat cushion including a seating surface, a first side bolster, a second side bolster and a face extending around said first side bolster and said second side bolster as well as across a front of said seat cushion;
a first storage compartment in said seat cushion, said storage compartment having an access opening in said face.

2. The seat assembly of claim 1, further including a cover overlying said access opening.

3. The seat assembly of claim 2, further including a security lock for said cover.

4. The seat assembly of claim 3, wherein said first storage compartment is provided in said first side bolster.

5. The seat assembly of claim 3, including a second storage compartment, said first storage compartment being provided in said first side bolster and said second storage compartment being provided in said second side bolster.

6. The seat assembly of claim 1, wherein said first storage compartment is tubular in shape.

7. The seat assembly of claim 5, further including a third storage compartment having a third access opening provided in said face at a front of said seat cushion between said first and second side bolsters.

8. The seat assembly of claim 7, wherein said third storage compartment includes a third cover overlying said third access opening.

9. The seat assembly of claim 8, further including a fourth storage compartment in said seat cushion having a fourth access opening and a fourth cover forming a part of said seating surface.

10. The seat assembly of claim 9, wherein said first, second, third and fourth storage compartments are molded plastic bins embedded in said seat cushion.

11. The seat assembly of claim 3, wherein said security lock is an electronic security lock.

12. The seat assembly of claim 11, wherein said electronic security lock is connected to a control module including a computing device.

13. The seat assembly of claim 12, wherein said control module further includes a human interface for entering a security code and operating said security lock.

14. The seat assembly of claim 12, wherein said control module further includes a speech processor for voice recognition and voice entry of a security code for operating said security lock.

15. A seat assembly, comprising:
a seat back;
a seat cushion;
a storage compartment provided in said seat cushion, said storage compartment including an access opening, a cover for said access opening and an electronic security lock for said cover; and
a control module for operating said electronic security lock, said control module including a computing device.

16. The seat assembly of claim 15, wherein said control module further includes a human interface for entering a security code and operating said security lock.

17. The seat assembly of claim 15, wherein said control module further includes a speech processor for voice recognition and voice entry of a security code for operating said security lock.

18. The seat assembly of claim 15, wherein said seat cushion is made of foam material and said storage compartment is formed by a molded plastic storage bin embedded into said foam material.

19. The seat assembly of claim 18, wherein said cover is hinged to said storage bin.

20. The seat assembly of claim 19, wherein said cover is provided in a face of said seat assembly so as to be readily accessible.
